(19) United States
(12) Patent Application Publication
(10) Pub. No.: US 2009/0047490 A1
(43) Pub. Date: Feb. 19, 2009

(54) OVENABLE MULTILAYERED FILM

(76) Inventors: Marc Scully, Aurora (CA); Russ Gehrke, Neenah, WI (US)

Correspondence Address: STOEL RIVES LLP - SLC, 201 SOUTH MAIN STREET, SUITE 1100, ONE UTAH CENTER, SALT LAKE CITY, UT, 84111, US

(21) Appl. No.: 12/038,796

(22) Filed: Feb. 27, 2008

Related U.S. Application Data
(63) Continuation of application No. 11/839,995, filed on Aug. 16, 2007.

(51) Int. Cl. B32B 27/32; B32B 7/02

(52) U.S. Cl. 428/213; 428/476.3

(57) ABSTRACT

A multilayer film including a first outermost layer comprising nylon, a first adhesive layer, one or more core layers comprising one or more polyolefins, a second adhesive layer, and a final outermost layer comprising nylon.

### RELATED APPLICATIONS

This application is a continuation of U.S. patent application Ser. No. 11/839,995 filed Aug. 16, 2007.

### BRIEF DESCRIPTION OF THE DRAWINGS

The present embodiments will become more fully apparent from the following description and appended claims, taken in conjunction with the accompanying drawings. Understanding that the accompanying drawings depict only typical embodiments, and are, therefore, not to be considered to be limiting of the scope of the present disclosure, the embodiments will be described and explained with specificity and detail in reference to the accompanying drawings as provided below.

FIG. 1 is a cross-section view of a multilayered film.

FIG. 2 is a cross-section view representing a multilayered film having at least seven layers.

FIG. 3 is a perspective view of an ovenable package comprising a multilayered film of the present invention.

FIG. 4 is a perspective view of an ovenable container comprising the multilayered film of the present invention.

### INDEX OF ELEMENTS IDENTIFIED IN THE DRAWINGS

100 multilayer film

110 first outermost layer

120 first adhesive layer

130 one or more core layers

140 second adhesive layer

150 final outermost layer

200 multilayer film

210 first outermost layer

220 first adhesive layer

230 third layer

240 fourth layer

250 fifth layer

260 sixth layer

270 second adhesive layer

280 final outermost layer

300 open package

310 seal

320 temporary seal

400 container

410 film

420 food tray

### DETAILED DESCRIPTION

It will be readily understood that the components of the embodiments as generally described and illustrated in the figures herein could be arranged and designed in a wide variety of different configurations. Thus, the following more detailed description of various embodiments, as represented in the figures, is not intended to limit the scope of the present disclosure, but is merely representative of various embodiments. While the various aspects of the embodiments are presented in drawings, the drawings are not necessarily drawn to scale unless specifically indicated. In the figures, like components are designated by like reference numerals throughout the several views.

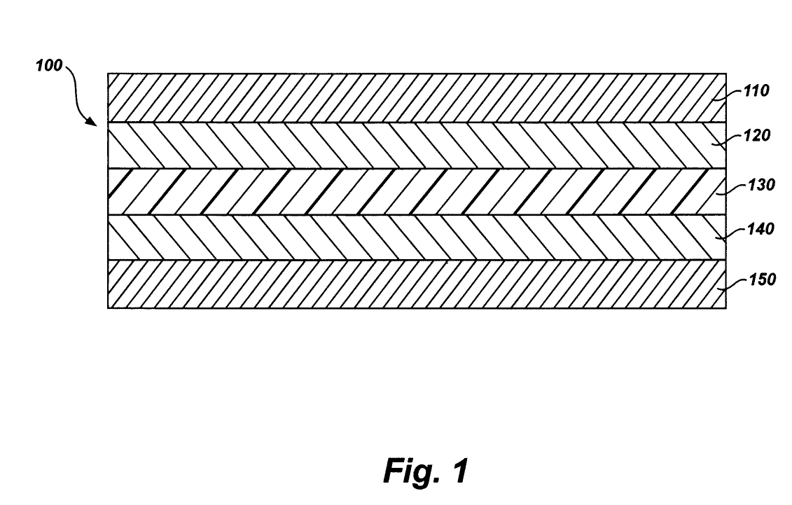

FIG. 1 shows a multilayer film 100 including one or more core layers 130. The first outermost layer 110 and the final outermost layer 150 form the outside surfaces of the multilayer film. A multilayer layer film, such as the multilayer film 100, may be a coextruded product that is for pouching or thermoforming applications and is heat sealable while maintaining integrity during a cooking cycle. The multilayer film 100 may be useful in various applications including those using heat sealable ovenable films, thermoformable ovenable films, hermetically sealed thermoformed ovenable films, and non-tube layflat films.

The first adhesive layer 120 and the second adhesive layer 140 of multilayer film 100 may be an adhesive layer. The multilayer film 100 includes one or more core layers 130. The first outermost layer 110 and the final outermost layer 150 of the multilayer film 200 may be made of the same polyamide or of different polyamides or blends of polyamides. Suitable polyamides may include those that are approved for direct food contact or those approved for use in a food packaging film. For example, the first outermost layer 110 and the final outermost layer 150 may each include 100% (wt.) of a nylon selected from a group including, for example, nylon 4,6, nylon 6, nylon 6,6, nylon 6,9, nylon 6,10, nylon 6,12, nylon 6/12, nylon 6/66, nylon 66/6, nylon 11, and nylon 12.

The one or more core layers 130 may include one or more polyolefin layers. The at least one or more core layers 130 may also include at least one barrier, such as an oxygen barrier, in one or more of the polyolefin layers. More particularly, the one or more core layers 130 may include one or more single polyolefin or blended polyolefin layers such as a high density polyethylene (HDPE) layer. Furthermore, the one or more core layers 130 may include a linear low density polyethylene (LLDPE) blended with low density polyethylene (LDPE). For example, the one or more core layers 130 may include one or more blended polyolefin layers with each layer preferably including at least approximately any of the following amounts of LLDPE based on the weight of the one or more core layers 130: 5%, 10%, 15%, 20%, 25%, 30%, 35%, 40%, 45%, 50%, 55%, 60%, 65%, 70%, 75%, 80%, 85%, 90%, and 95%. For example, the one or more blended polyolefin layers of the least one core layer 130 may also include at least approximately any of the following amounts of LDPE based on the weight of the one or more core layers 130: 5%, 10%, 15%, 20%, 25%, 30%, 35%, 40%, 45%, 50%, 55%, 60%, 65%, 70%, 75%, 80%, 85%, 90%, and 95%. Exemplary commercially available LLDPEs include the product sold under the trademark NOVA SCLAIR® FP120c. Exemplary commercially available LDPEs include the product sold as ExxonMobil 105.3.

One of the functions served by the first adhesive layer 120 is an adhesive layer to bond the first outermost layer 110 and the one or more core layers 130 that is directly contacting the first adhesive layer 120. Likewise, one of the functions of the second adhesive layer 140 is to bond the final outermost layer 150 together with the one or more core layers 130. Examples of suitable commercially available adhesives are sold by DuPont Chemical Company, Wilmington, Del., U.S.A. under the trademark BYNEL® 41E687.

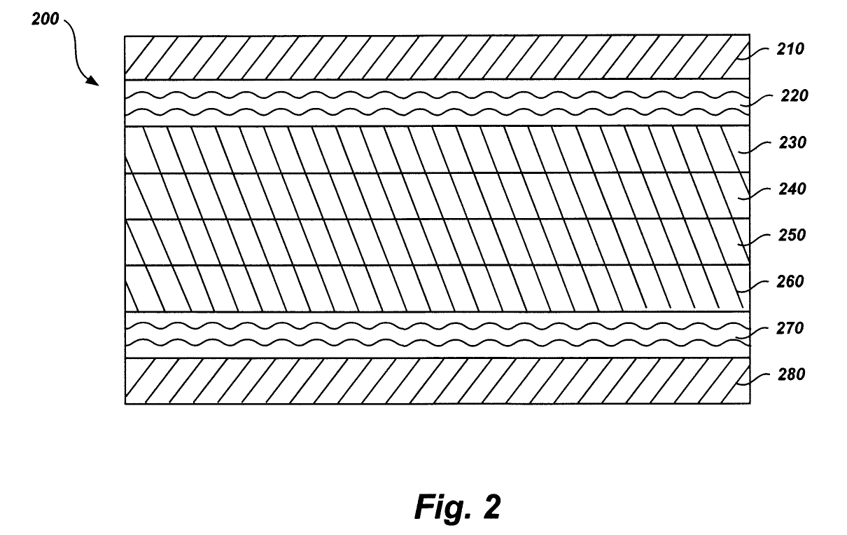

With reference to FIG. 2, multilayer film 200 includes a first outermost layer 210 and a final outermost layer 280 which comprise the surfaces of the multilayer film 200. The first adhesive layer 220 and a second adhesive layer 270 may be similar or different adhesive tie layers. The multilayer film 200 may also include polyolefin core layers such as a third layer 230, a fourth layer 240, a fifth layer 250, and a sixth layer 260. The polyolefin core layers 230, 240, 250 and 260 may include a barrier, such as an oxygen barrier. The core layers 230, 240, 250 and 260 together may comprise at least approximately 45%, 50%, 55%, 60%, or at least approximately 65% of the total thickness of the multilayer film 200.

The first outermost layer 210 and the final outermost layer 280 of the multilayer film 200 may each be made of the same polyamide. Alternatively, the first outermost layer 210 and the final outermost layer 280 may be made of different polyamide or mixtures of polyamides. Suitable polyamides may include those that are approved for direct food contact or those approved for use in a food packaging film. For example, the first outermost layer 210 and the final outermost layer 280 may each include 100% (wt.) of a nylon in order to provide heat resistance to a package in an end-use thermal processing as well as providing heat resistance to the outer surface during heat sealing of a pouch or heat sealing of a top web onto a formed bottom web. The first outermost layer 210 and the final outermost layer 280 may each include 100% (wt.) of a nylon selected from a group including, for example, nylon 4,6, nylon 6, nylon 6,6, nylon 6,9, nylon 6,10, nylon 6,12, nylon 6/12, nylon 6/66, nylon 66/6, nylon 11, and nylon 12.

One of the functions served by the first adhesive layer 220 is an adhesive layer to bond the first outermost layer 210 and the third layer 230. Likewise, one of the functions of the second adhesive layer 270 is to bond the final outermost layer 280 together with the sixth layer 260. The first adhesive layer 220 and the second adhesive layer 270 may be comprised of suitable commercially available adhesives such as those sold by DuPont Chemical Company, Wilmington, Del., U.S.A. under the trademark BYNEL® 41E687.

The layers 230, 240, 250, and 260 may each comprise one or more polyolefins. More particularly, the layers 230, 240, 250, and 260 may each may include HDPE, LLDPE, and/or LDPE. Also, the layers 230, 240, 250, and 260 each include a LLDPE blended with low-density polyethylene LDPE. For example, the polyolefin layers 230, 240, 250, and 260 each may include one or more blended polyolefins with at least approximately any of the following amounts of LLDPE based on the weight of the individual layer: 5%, 10%, 15%, 20%, 25%, 30%, 35%, 40%, 45%, 50%, 55%, 60%, 65%, 70%, 75%, 80%, 85%, 90%, and 95% LLDPE. For example, the polyolefin layers 230, 240, 250, and 260 may include at least approximately any of the following amounts of LDPE based on the weight of the individual layer: 5%, 10%, 15%, 20%, 25%, 30%, 35%, 40%, 45%, 50%, 55%, 60%, 65%, 70%, 75%, 80%, 85%, 90%, and 95% LDPE. More particularly, and by way of example only, the polyolefin layers 230, 240, 250, and 260 may include 75% (wt.) LLDPE and the remaining percentage 25% (wt.) LDPE. Exemplary commercially available LLDPEs may be sold under the trademark NOVA SCLAIR® FP120c. Exemplary commercially available LDPEs include the product sold as ExxonMobil 105.3.

The thickness of a multilayer film according to the present invention may be less than approximately 10 mils, more preferably less than approximately 7 mils, and most preferably from approximately 3 mils to approximately 7 mils. For purposes of example only, and not meant as a limitation, the multilayer film 200 may have a thickness of approximately 6 mils. For example, the thickness of the first outermost layer 210 and the final outermost layer 280 may each have a thickness from approximately 0.3 to 2 mils, and each comprise from approximately 10-20% of the multilayer film 200. The thickness of the first adhesive layer 220 and the second adhesive layer 270 is each preferably from approximately 0.1-0.4 mils with each comprising approximately from 1-10% of the total thickness of the multilayer film 200. The thickness of the core layers 230, 240, 250, and 260 may each be in a range from approximately 1-40% of the total thickness of the multilayer film 200. For example each of the layers 230, 240, 250, and 260 may be from approximately 0.1-3.0 mils thick and may be adjusted according to the desired overall thickness of the multilayer film.

The following examples multilayer films are provided for the purpose of representation and are not to be construed as limiting the scope of the invention.

### EXAMPLE 1

In one example, a multilayer film with a thickness of 6 mils was made according to TABLE 1:

TABLE 1

| | | | % of total film | |
|---|---|---|---|---|
| Layer | Material | Wt. % of layer | thickness | mil |
| 1 | Nylon 6/66 | 100% | 16% | 0.96 |
| 2 | Adhesive | 100% | 5% | 0.31 |
| 3 | LLDPE/LDPE | 75%/25% | 34% | 2.03 |
| 4 | LLDPE/LDPE | 75%/25% | 5.5% | 0.34 |
| 5 | LLDPE/LDPE | 75%/25% | 13% | 0.78 |
| 6 | LLDPE/LDPE | 75%/25% | 5.5% | 0.34 |
| 7 | Adhesive | 100% | 5% | 0.31 |
| 8 | Nylon 6/66 | 100% | 16% | 0.96 |

### EXAMPLE 2

In yet another example, a multilayer film with a thickness of 3 mils was formed according to TABLE 2:

TABLE 2

| | | | % of total film | |
|---|---|---|---|---|
| Layer | Material | Wt. % of layer | thickness | mil |
| 1 | Nylon 6/66 | 100% | 12% | 0.37 |
| 2 | Adhesive | 100% | 5% | 0.15 |
| 3 | LLDPE/LDPE | 75%/25% | 33% | 0.99 |
| 4 | LLDPE/LDPE | 75%/25% | 6% | 0.18 |
| 5 | LLDPE/LDPE | 75%/25% | 13% | 0.4 |
| 6 | LLDPE/LDPE | 75%/25% | 6% | 0.18 |
| 7 | Adhesive | 100% | 5% | 0.15 |
| 8 | Nylon 6 | 100% | 20% | 0.60 |

### EXAMPLE 3

A multilayer layer film may also be formed as shown by TABLE 3:

TABLE 3

| | | | % of total film | |
|---|---|---|---|---|
| Layer | Material | Wt. % of layer | thickness | mil |
| 1 | Nylon 6/66 and | 98% nylon 6/66 | 16% | 0.96 |
| | Nylon 6 | 2% nylon 6 | | |
| 2 | Adhesive | 100% | 5% | 0.31 |
| 3 | LLDPE/LDPE | 75%/25% | 34% | 2.03 |
| 4 | LLDPE/LDPE | 75%/25% | 5.5% | 0.34 |
| 5 | LLDPE/LDPE | 75%/25% | 13% | 0.78 |
| 6 | LLDPE/LDPE | 75%/25% | 5.5% | 0.34 |
| 7 | Adhesive | 100% | 5% | 0.31 |
| 8 | Nylon 6/66 | 100% | 16% | 0.96 |

The multilayered film maybe formed by several conventional methods. The multilayered film may be manufactured using typical bubble blown film processes and machines and cast film processes and machines without having to modify the machine or equipment. The multilayered film may be oriented or non-oriented.

In one embodiment, an extruder can be used to form the multilayer film and may include a series of individual extruders for each material to form a separate layer having its own extruder. Alternatively, a coextruder that can extrude two or more materials through a single die with two or more orifices arranged so that the extruded materials merge into a laminar structure may also be used. As known by those of skill in the art, polyamide, polyolefin and other desired materials for use in forming the multilayer film may be melted in an extruder to produce a molten material, each of which is then forced through a die to produce a layered laminar structure. The layered laminar structure may then be formed into a multilayered film by conventional blown film processes, as understood by those of ordinary skill in the art of film manufacturing.

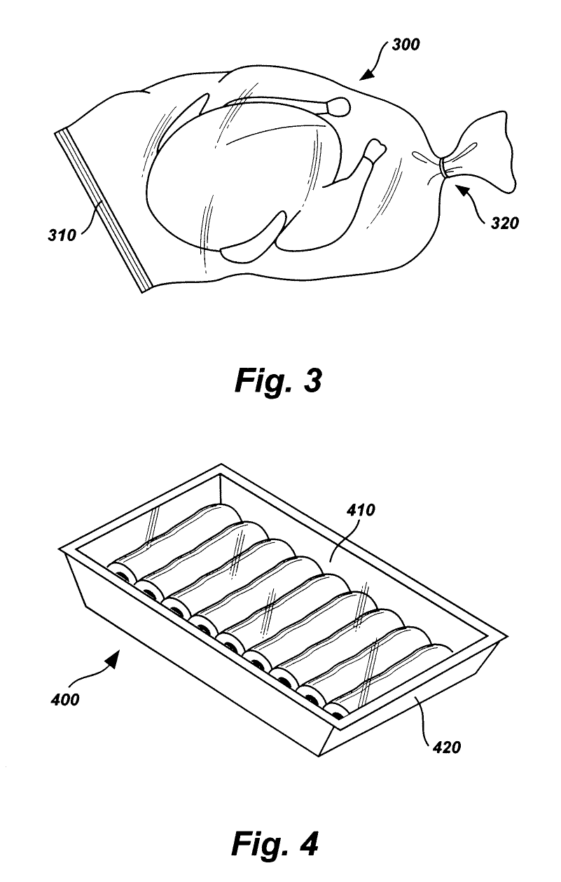

As shown by FIG. 3, the multilayer film of the present invention may be used in cooking or packaging an article or object such as food, where the food packaging may be exposed to microwave or conventional oven conditions or both (i.e., dual ovenable) to heat or cook the food. Such food may comprise for example, fresh, raw, partially-cooked, or cooked food, such as meat products, poultry, and pre-prepared products such as pizza and pasta. The multilayered film of the present invention may be heat sealed to either another film or to itself by a seal 310 to form an open package 300 such as a bag, pouch (e.g., vertical or horizontal form-fill-sealed pouch), tube, or other containment configuration in which the article to be cooked or packaged is placed before the package is sealed closed by temporary seal 320 or another seal 310.

Referring to FIG. 4, the multilayered film of the present invention may be heat sealed to a substrate such as a food tray 420. The food product may be placed on the food tray 420 and the film 410 may then be positioned over the food and heat sealed to the food tray 420 to hermetically enclose the food product and form container 400 enclosing the food product. The food may then be heated, reheated, or cooked by placing the food enclosed in the package 300 or the container 400 in an oven and activating the oven to heat or cook the food to a desired level.

Without further elaboration, it is believed that one skilled in the art can use the preceding description to utilize the present disclosure to its fullest extent. The examples and embodiments disclosed herein are to be construed as merely illustrative and not a limitation of the scope of the present disclosure in any way. It will be apparent to those having skill in the art that changes may be made to the details of the above-described embodiments without departing from the underlying principles of the disclosure described herein. In other words, various modifications and improvements of the embodiments specifically disclosed in the description above are within the scope of the appended claims. The scope of the invention is therefore defined by the following claims.

What is claimed is:

1. A multilayer film comprising:
a first outermost layer consisting of nylon;
a first adhesive layer;
at least one core layer comprising at least one polyolefin;
a second adhesive layer;
a final outermost layer consisting of nylon;
wherein the first adhesive layer is disposed between the first outermost layer and the at least one core layer; and
wherein the second adhesive layer is disposed between the final outermost layer and the at least one core layer.

2. The multilayer film of claim 1, wherein the first outermost layer and the final outermost layer each comprise approximately 100% of the same nylon.

3. The multilayer film of claim 1, wherein the first outermost layer comprises approximately 100% (wt.) of a first nylon and the final outermost layer comprises approximately 100% (wt.) of a second nylon.

4. The multilayer film of claim 1, wherein the first outermost layer and the final outermost layers are nylon 4,6, nylon 6, nylon 6,6, nylon 6,9, nylon 6,10, nylon 6,12, nylon 6/12, nylon 6/66, nylon 66/6, nylon 11, nylon 12 or mixtures thereof.

5. The multilayer film of claim 1, wherein the first adhesive layer and the second adhesive layer comprise a linear low-density polyethylene (LLDPE) resin.

6. The multilayer film of claim 1, wherein the at least one core layer comprises a high density polyethylene (HDPE).

7. The multilayer film of claim 1, wherein the at least one core layer comprises at least four layers and each of the at least four layers comprises a blend of a linear low-density polyethylene (LLDPE) and a low-density polyethylene (LDPE).

8. The multilayer film of claim 7, wherein each of the at least four polyolefin layers comprises approximately 75% (wt.) of a linear low-density polyethylene (LLDPE) and approximately 25% (wt.) of a low-density polyethylene (LDPE).

9. The multilayer film of claim 1, wherein the first outermost layer is approximately 10-20% of the total thickness of the multilayered film;
wherein the first adhesive layer is approximately 1-10% of the total thickness of the multilayered film;
wherein the at least one core layer is approximately 55-65% of the total thickness of the multilayered film;
wherein the second adhesive layer is approximately 1-10% of the total thickness of the multilayered film; and
wherein the final outermost layer is approximately 10-20% of the total thickness of the multilayered film.

10. A multilayer film comprising:
a first outermost layer comprising approximately 100% of a 6/66 nylon;
a first adhesive layer;
at least one core layer comprising at least one polyolefin;
a second adhesive layer;
a final outermost layer comprising a nylon 6/66 blended with a nylon 6;
wherein the first adhesive layer is disposed between the first outermost layer and the at least one core layer; and
wherein the second adhesive layer is disposed between the final outermost layer and the at least one core layer.

11. The multilayer film of claim 10, wherein the final outermost layer comprising a nylon blend consists of at least approximately 90-98% (wt.) of a 6/66 nylon and at least approximately 2-10% (wt.) of a nylon 6.

12. The multilayer film of claim 10, wherein the at least one core layer further comprises at least one layer comprising approximately 60-85% (wt.) of a linear low-density polyethylene (LLDPE) and approximately 15-40% (wt.) of a low-density polyethylene (LDPE).

13. The multilayer film of claim 10, wherein the at least one core layer consists of four layers, wherein each of the four layers comprises approximately 60-85% (wt.) of a linear low-density polyethylene (LLDPE) and approximately 15-40% (wt.) of a low-density polyethylene (LDPE).

14. A multilayer film comprising:
a first outermost layer comprising approximately 100% of a type 6 nylon;
a first adhesive layer;
at least one core layer comprising at least one polyolefin;
a second adhesive layer;
a final outermost layer comprising approximately 100% of a 6/66 nylon;
wherein the first adhesive layer is disposed between the first outermost layer and the at least one core layer; and
wherein the second adhesive layer is disposed between the final outermost layer and the at least one core layer.

15. The multilayer film of claim 14, wherein the at least one core layer further comprises at least one layer comprising approximately 60-85% (wt.) of a linear low-density polyethylene (LLDPE) and approximately 15-40% (wt.) of a low-density polyethylene (LDPE).

16. The multilayer film of claim 14, wherein the at least one core layer consists of four layers, wherein each of the four layers comprises approximately 60-85% (wt.) of a linear low-density polyethylene (LLDPE) and approximately 15-40% (wt.) of a low-density polyethylene (LDPE).
